(19) United States
(12) Patent Application Publication
(10) Pub. No.: US 2018/0238446 A1
(43) Pub. Date: Aug. 23, 2018

(54) SHIFT LINKAGE ASSEMBLY FOR A MANUAL TRANSMISSION

(71) Applicant: GM Global Technology Operations LLC, Detroit, MI (US)

(72) Inventor: Barry Hensel, CANTON, MI (US)

(21) Appl. No.: 15/438,068

(22) Filed: Feb. 21, 2017

(51) Int. Cl. F16H 61/36; F16H 59/04; F16C 1/06; F16C 1/20

(52) U.S. Cl. CPC F16H 61/36; F16C 1/20; F16C 1/06; F16H 59/04

(57) ABSTRACT

A gear selector assembly configured to establish a mechanical connection between an operator of the vehicle and a gear selector of a manual transmission. The gear selector assembly includes a gear shift lever and a shift linkage assembly. The gear shift lever includes a shift output member configured for rotational and axial movements in response to the movements of the gear shift level. The shift linkage assembly includes a shift cable rod having a flexible cable, a flexible housing surrounding the flexible cable, and a housing jacket surrounding the flexible housing. The flexible cable includes an input end configured to operably connect to the shift output member for receiving the rotational and axial movements, and an opposite output end configured to operably connect to the gear selector for transmitting the rotational and axial movements to the gear shift selector.

### INTRODUCTION

The present disclosure relates to a shift linkage between a shifter and a transmission for a motor vehicle, and more particularly to a cable shift linkage between a stick shifter and a gear selector of a manual transmission.

A motor vehicle typically includes a transmission as part of the drive train. The transmission provides a plurality of forward gear ratios and generally one reverse gear ratio. The plurality of gear ratios allows the speed of the internal combustion engine or electric motor to be maintained within its optimal operating range for the delivery of torque to propel the motor vehicle. The transmission may be an automatic transmission where the desired gear ratio is automatically selected by the transmission or transmission controller based on predetermined factors such as the speed of the motor vehicle and the throttle position of the motor vehicle. The transmission may also be that of a manual transmission where the desired gear ratio is manually selected by the operator of the motor vehicle moving a shift lever from one gear ratio position to another gear ratio position. The movement of the shift lever produces rotational and axial movements that are transferred to the gear selector located on the manual transmission by way of a mechanical shift linkage. The gear selector of the manual transmission operates shift forks within the manual transmission to engage the selected gears ratios based on the rotational and axial movements transmitted by the mechanical shift linkage.

The mechanical shift linkage typically includes a rigid shift rod having a first end coupled to the shift lever and an opposite second end coupled to the gear selector on the manual transmission. A mechanical shift linkage having a shift rod is adequate where the shift lever is relatively near the gear selector. However, shift feel may be compromised where there is a significant distance between the shift lever and gear selector. For improved weight distribution, front engine high performance motor vehicles may have the manual transmission mounted over the rear drive axle. The distance between the shift lever and gear selector on the manual transmission is increased due to the rearward remote location of the manual transmission. To accommodate for the increased distance and packaging consideration, the shift rod is lengthened and contorted between the shift lever and the gear selector of the manual transmission resulting in an axial off-set between the input end of the shift rod and the output end of the shift rod.

Due to the increase in length and contortion of the shift rod, the shift rod may twist along its length and/or bend, thus resulting in diminished or delayed transmittal of the rotational and axial movements to the gear selector. The diminished or delayed transmittal of rotational and axial movements may lead to a spongy, notchy, and/or non-responsive feel of the shift lever, thus resulting in increased shifting efforts in selecting the desired gear ratios.

Thus, while the current shift rod achieves its intended purpose of mechanically linking the shift lever to the gear selector, there remains a need for a new and improvement mechanical shift linkage that is more precise in transmitting the rotational and axial movements induced from the shift lever to the gear selector, thus improving shift feel, reducing shift effort, and resulting in shorter shift time between gear ratios.

### SUMMARY

According to several aspects, the present disclosure provides a shift cable rod for a shift linkage assembly for establishing a mechanical connection between a gear shift lever and a gear selector on a manual transmission. The shift cable rod includes a flexible cable having an input end and an output end opposite the input end. The input end is configured to receive a rotational movement and an axial movement from a gear shift lever and the output end is configured to transmit the rotational and axial movements to a gear selector. The flexible cable includes a diameter sufficiently large with respect to the overall length of the cable such that the difference in rotation due to elastic deformation between the input end and output end is less than a predetermined value.

In an additional aspect of the present disclosure, the flexible cable further includes a single wire core interconnecting the input end and the output end and a plurality of wire bundles wound onto the wire core. The plurality of wire bundles cooperates with the single wire core to transmit the rotational and axial movements from the input end to the output end.

In another aspect of the present disclosure, the shift cable rod includes a flexible housing coaxially disposed about the flexible cable. The flexible housing includes an interior surface in intimate contact with the flexible cable such that such that the flexible housing supports the flexible cable while permitting the flexible cable to freely rotate and axially slide within the flexible housing.

In another aspect of the present disclosure, the shift cable rod further includes a jacket disposed onto the exterior surface of the flexible housing. The jacket defines a plurality of axially extending ribs.

In another aspect of the present disclosure, the single wire core includes a plurality of braided wire strands. Each of the wired bundles is formed of a plurality of twisted or braided wire strands.

According to several aspects, the disclosure also provides for a shift linkage assembly for a manual transmission of a motor vehicle, having a shift rod cable including a flexible cable, a flexible housing coaxially disposed about the flexible cable, and a housing jacket disposed on the flexible housing. The flexible cable includes an input end configured to operably connect to an output member of a shift lever for receiving a rotational movement and an axial movement and an opposite output end configured to operably connect to a gear selector on the transmission for transmitting the rotational and axial movements. The flexible cable has a torsional stiffness sufficient to transmit substantially the same degree of rotational movement received by the input end to the output end and an axial stiffness sufficient to transmit substantially the same length of axial movement received by the input end to the output end.

In an additional aspect of the present disclosure, the shift linkage assembly further includes an input coupling configured to connect the input end of the flexible cable for common rotational movement and axial movement with an output member of the shift lever and an output coupling configured to connect the output end of the flexible cable for common rotational movement and axial movement with the gear selector of the transmission.

In another aspect of the present disclosure, the shift linkage assembly further includes a plurality of brackets for grounding the shift linkage assembly to a support structure of the motor vehicle.

In another aspect of the present disclosure, the input axis extending from the input end of the flexible cable is radially offset and non-parallel to an output axis extending from the output end of the flexible cable.

In another aspect of the present disclosure, the flexible housing guides the axial translational movement of the flexible cable without inhibiting the rotational movement of the flexible cable.

In another aspect of the present disclosure, the flexible cable includes a central flexible wire core and a plurality of wire bundles spirally wrapped onto the central wire core to buttress the central wire core from plastic deformation due to the rotational and axial translational movements.

According to several aspects, the disclosure further provides for a manual gear selector assembly having a shift lever configured to slideably pivot through a predetermined pattern for the selection of desired gear ratios and an output member configured to transmit a rotational movement and an axial translational movement based on the selected gear ratio, and a shift linkage assembly including a shift cable rod having a flexible cable. The flexible cable includes an input end coupled for common rotational movement and axial translational movement with the output member of the shift lever and an opposite output end configured to couple to a gear selector of the manual transmission for common rotational movement and axial translational movement with the gear selector.

In an additional aspect of the present disclosure, the flexible cable is configured to transmit substantially the same amount of rotational movement and translation movement received from the output member of the shift lever to the gear selector.

In another aspect of the present disclosure, an input axis extending from the input end of the flexible cable is radially offset and non-parallel to an output axis extending from the output end of the flexible cable.

In another aspect of the present disclosure, the shift cable rod further includes a flexible housing coaxially disposed about the flexible cable, a lubricant disposed between the flexible housing and flexible cable, and a housing jacket disposed on the flexible housing, wherein the housing jacket defines a plurality of ribs extending the length of the cable shift rod.

In another aspect of the present disclosure, the flexible cable includes a central flexible wire core and a plurality of wire bundles spirally wrapped onto the central wire core to buttress and reinforce the central wire core from deformation due to the torsional, compression, and tensile forces such that the rotational movement and axial translational movement received by the input end is common with the rotational movement and axial translational movement transmitted through the flexible cable to the output end.

In yet another aspect, the manual gear selector assembly further includes a plurality of brackets for grounding the shift linkage assembly to a support structure of the motor vehicle.

In yet another aspect, the input end is oriented toward the front of the vehicle and the output end is oriented toward the rear of the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an exemplary manual gear shift assembly having a shift cable rod for a manual transmission of a motor vehicle according to an exemplary embodiment;

FIG. 1A shows a double-H shift pattern for an exemplary six speed manual transmission according to an exemplary embodiment; and

FIG. 2 is a perspective cut-a-way view of the shift cable rod of the manual gear shift assembly of FIG. 1.

### DETAILED DESCRIPTION

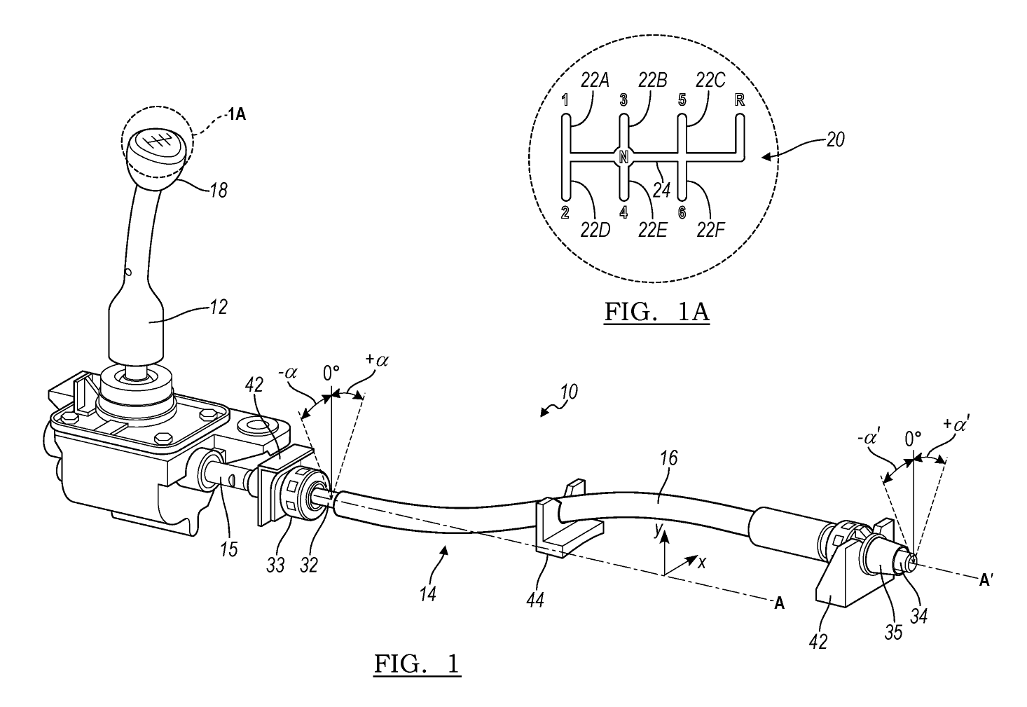

The following description is merely exemplary in nature and is not intended to limit the present disclosure, application, or uses. Shown in FIG. 1 is an exemplary embodiment of a manual gear selector assembly 10 for a manual transmission (not shown) of a motor vehicle. The manual gear selector assembly 10 establishes a mechanical connection between an operator of the vehicle and a gear selector (not shown) of the manual transmission. The manual gear selector assembly 10 includes a gear selector lever 12, also known as a shift lever 12, and a shift linkage assembly 14. The shift lever 12 includes a shift output member 15 configured to rotate about an axis A and move in an axial direction along the axis A in response to the movements of the shift lever 12 through a predetermined shift pattern 20. The shift linkage assembly 14 includes a shift cable rod 16 mechanically linking the rotational and axial movements of the shift output member 15 to the gear selector that extends along an axis A′. In other words, the shift cable rod 16 transmits both the rotational and axial translational movements from the shift output member 15 extending along the axis A to the gear selector extending along the axis A′. The axis A′ may be radially off-set from the axis A in the x and y directions, and the axis A′ need not be parallel to the axis A.

Shown in FIG. 1A is a double-H shift pattern 20 displayed on the input end 18 of the shift lever 12 for a manual transmission having six (6) forward gear ratios and one (1) reverse gear ratio R, also known as a manual six speed transmission. The first, third, and fifth gear ratios are located on the top vertical slots 22A, 22B, 22C of the double-H pattern 20 and the second, fourth, and sixth gear ratios are located on the bottom vertical slots 22D, 22E, 22F of the double-H pattern 20. The top slots 22A, 22B, 22C are oriented toward the front of the motor vehicle and the bottom slots 22D, 22E, 22F are oriented toward the rear of the motor vehicle. Neutral is located along the horizontal slot 24 that interconnects the top and bottom slots 22A, 22B, 22C, 22D, 22E, 22F. The shift lever 12 normally returns to a neutral position N between the third and fourth gear ratio slots 22B, 22E. While a double-H shift pattern 20 is shown for the manual six speed transmission, the gear shift assembly 10 is not meant to be limited for use to such a pattern 20 or to a manual six speed transmission. The exemplary embodiment of the gear shift assembly 10 may be used for any manual transmissions having a gear selector configured to receive both rotational and axial movements from a gear shift lever 12 for the selection of gear ratios.

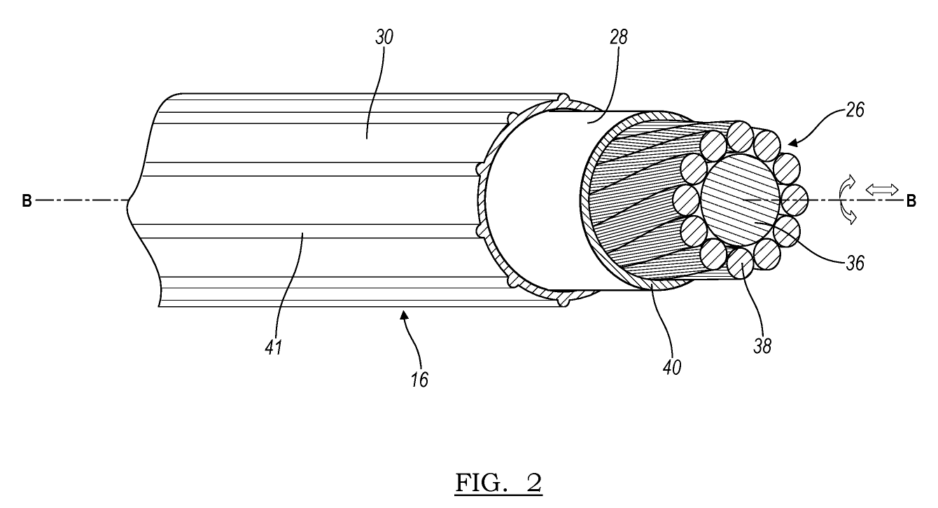

Referring to FIG. 2, the shift cable rod 16 includes a flexible cable 26, a flexible housing 28 surrounding the flexible cable 26, and a housing jacket 30 surrounding the flexible housing 28. Best shown in FIG. 1, the flexible cable 26 includes an input end 32 having an input coupling 33 connecting to the shift output member 15 for common rotational and axial movements with the shift output member 15 along the axis A. The flexible cable 26 also includes an output end 34, opposite of that of the input end 32, having an output coupling 35 configured to connect to the gear selector for common rotational and axial movements with the gear selector along the axis A′.

The flexible cable 26 shown is formed of a flexible single central solid wire core 36 extending the length of the flexible cable 26 along longitudinal axis B and a plurality of wire bundles 38 tightly wounded onto the flexible single central solid wire core 36. Each of the wire bundles 38 may include a plurality of twisted or braided wire strands. The wire bundles 38 are spirally wounded or braided onto the solid wire core 36 to buttress and reinforce the solid wire core 36 such that the assembled flexible cable 26 is not subjected to excessive elastic deformation due to tensile, compression, or torsional forces experienced during the normal operating condition of the shift linkage assembly 14. It is preferable the solid wire core 36 and wire bundles 38 are formed of a high tensile strength and corrosion resistant material, such as that of stainless steel. Alternatively, the flexible cable 26 may be formed of a plurality of wire bundles 38 braided into a flexible cable 26 without the flexible solid wire core 36.

The flexible housing 28 is co-axially disposed about the flexible cable 26. The flexible housing 28 includes an interior surface 40 that is in intimate contact with the flexible cable 26 such that such that the flexible housing 28 supports the flexible cable 26 while permitting the flexible cable 26 to freely rotate and freely slide axially in both directions along the longitudinal axis B. It should be noted that the longitudinal axis B need not be linear and follows the curves of the flexible cable 26 as it extends between the input end 32 and output end 34. The flexible housing 28 is preferably formed of a material that is resistant to wear caused by the fore, aft, and rotational movements of the flexible cable 26 and is corrosion resistant, such as that of stainless or galvanized steel. The flexible housing 28 may be manufactured from a helically wound square steel wire or woven steel wire strands. A cable lubricant may be injected between the flexible cable 26 and flexible housing 28 to provide the ease of rotational and axial movement of the flexible cable 26 within the flexible housing 28.

The housing jacket 30 is formed of a polymer sheathing coated onto or disposed about the exterior surface of the flexible housing 28 to protect the flexible housing 28 and flexible cable 26 from the harsh operating environment of the motor vehicle, such as heat from the vehicle exhaust system, vehicle fluids, and corrosive road debris such as road salts. It is preferable that the jacket is formed of a corrosion resistant polymers such as polyvinylchloride (PVC), polyurethane (TPU), nylon, or other known plastic polymers that provide the durability to protect the flexible housing 28 and flexible cable 26 from the environmental elements. The housing jacket 30 defines a plurality of ribs 41 extending the length of the housing jacket 30. The longitudinally extending ribs 41 provide structural integrity to the housing jacket 30.

Referring back to FIG. 1, the shift linkage assembly 14 is mounted onto a support structure (not shown) of a motor vehicle such, as a torque tunnel, with mounting brackets 42 and supports 44. The mounting brackets 42 are configured to fix, or ground, the shift cable rod 16 onto the support structure to limit axially axial movement of the shift cable rod 16 while allowing for the flexible cable 26 to freely slide in the fore and aft directions within the length of the flexible housing 28 of the shift cable rod 16 as well as freely rotate within the flexible housing 28 without binding or deforming of the flexible cable 26. The supports 44 maintains the shift cable rod 16 in a predetermined position and in a predetermined route between the shift output member 15 and gear selector.

In the exemplary embodiment shown, the shift cable rod 16 is flexed into an S-shape to accommodate for the packaging of the drive train assembly, resulting in the output end 34 being radially offset from the input end 32 in both the x and y directions. The operator of the vehicle slideably pivots the shift lever 12 through the double-H pattern 20 for the selection of desired gear ratios. The shift output member 15 rotates and moves in the fore and aft direction along the axis A based on the operator's selection of gear ratios through the double H pattern 20. The flexible cable 26 of the shift cable rod 16 of the shift linkage assembly 14 transfers both the rotational and axial movements from the shift output member 15 to the gear selector on the manual transmission. The flexible cable 26 is coupled for common rotational and axial movements with the shift output member 15. The rotation and axial movements are transferred by flexible cable 26 to the output end 34 which is configured to be coupled for common rotational and axial movements with the gear selector of the manual transmission.

In a first example, the vehicle operator selects the first gear ratio from neutral N by slideably pivoting the shift lever 12 from neutral N to the left and forward into the slot 22A, thereby causing the shift output member 15 to rotate in a first rotational direction and move in a first axial direction. The first rotational direction and first axial direction movements are transferred by the flexible cable 26 of the shift cable rod 16 to the gear selector. In a second example, the vehicle operator selects the fourth gear ratio from first gear ratio by slideably pivoting the shift lever 12 rearward from the first gear slot 22A to the neutral position N and slideably pivoting rearward again into the gear slot 22E, thereby causing the shift output member 15 to move in a second axial direction, rotate in a second direction, and again move in the second axial direction. The second axial direction, rotation in the second direction, and the once more second axial direction movements are transferred by the flexible cable 26 of the shift cable rod 16 to the gear selector.

To enable the precision of transmitting the rotational and axial translational movements of the shift lever 12 by the flexible cable 26 to the gear selector, the flexible cable 26 must be sufficiently robust to withstand the tensile, compression, and torsional forces without significant elastic or permanent deformations of the flexible cable 26 that would result in delay in shifting or non-shift events. Such deformation would include stretching of the flexible cable 26 due to tensile forces, compressing of the cable due to compressional forces, and twisting of the cable due to torsional forces. In other words, the flexible cable 26 includes a torsional stiffness sufficient to transmit substantially the same degree of rotational movement received by the input end 32 to the output end 34, and an axial stiffness sufficient to transmit substantially the same length of axial movement received by the input end 32 to the output end 34 to avoid delay or diminishment of the rotational and axial movements.

For example, the shift from neutral N to slot 22A for the first gear ratio may result in an angle α of −15 to −20 degree rotation of the cable where neutral N is 0 degree. Similarly, the shift from neutral N to slot 22F for the sixth gear ratio may result in a +15 to +20 degree rotation, therefore the flexible cable 26 see a maximum total rotation of 30 to 40 degrees from the first gear slot 22A to the sixth gear slot 22F. The diameter of the flexible cable 26 should be sufficiently large with respect to the overall length of the cable such that the difference in degree of rotation between the input angle (α) and output angle (α′) of the flexible cable 26 is less than a predetermine value, above which would result in delay in activating the gear selector or decreased precision of the shifts.

A shift linkage assembly 14 having a shift cable rod 16 of the present disclosure offers several advantages. These include precise transmittal of both rotational and axial movements induced from the shift lever 12 to the gear selector, thus improving shift feel, reducing shift effort, and resulting in shorter shift time between gear ratios. Another advantage is the shift cable rod enables transmittal of rotational and axial translational movements where the input axis A and the output axis A′ are off-set and not parallel. Yet another advantage is that the shift cable rod 16 offers improved packaging of the shift linkage assembly 14 in confined spaces.

The description of the present disclosure is merely exemplary in nature and variations that do not depart from the gist of the present disclosure are intended to be within the scope of the present disclosure. Such variations are not to be regarded as a departure from the spirit and scope of the present disclosure.

The following is claimed:

1. A shift cable rod for a shift linkage assembly for establishing a mechanical connection between a gear shift lever and a gear selector on a manual transmission, comprising:
a flexible cable having an input end and an output end opposite the input end;
wherein the input end is configured to receive a rotational movement and an axial movement from the gear shift lever, and
wherein the output end is configured to transmit the rotational and axial movement to the gear selector.

2. The shift cable rod of claim 1, wherein the flexible cable includes a diameter sufficiently large with respect to the overall length of the cable such that the difference in rotation due to elastic deformation between the input end and output end is less than a predetermined value.

3. The shift cable rod of claim 2, wherein the flexible cable further includes:
a single wire core interconnecting the input end and the output end; and
a plurality of wire bundles wound onto the wire core, wherein the plurality of wire bundles cooperates with the single wire core to transmit the rotational and axial movements from the input end to the output end.

4. The shift cable rod of claim 3 further comprising a flexible housing coaxially disposed about the flexible cable, wherein the flexible housing includes an interior surface in intimate contact with the flexible cable such that such that the flexible housing supports the flexible cable while permitting the flexible cable to freely rotate and axially slide within the flexible housing.

5. The shift cable rod of claim 4 further comprising a jacket disposed onto an exterior surface of the flexible housing, wherein the jacket defines a plurality of axially extending ribs.

6. The shift cable rod of claim 3, wherein the single wire core comprises a plurality of braided wire strands.

7. The shift cable rod of claim 3, wherein each of the wired bundles comprises a plurality of twisted or braided wire strands.

8. A shift linkage assembly for a manual transmission of a motor vehicle, comprising:
a shift rod cable comprising a flexible cable, a flexible housing coaxially disposed about the flexible cable, and a housing jacket disposed on the flexible housing;
wherein the flexible cable includes an input end configured to operably connect to an output member of a shift lever for receiving a rotational movement and an axial movement and an opposite output end configured to operably connect to a gear selector on the transmission for transmitting the rotational and axial movements,
wherein the flexible cable includes a torsional stiffness sufficient to transmit substantially the same degree of rotational movement received by the input end to the output end and an axial stiffness sufficient to transmit substantially the same length of axial movement received by the input end to the output end.

9. The shift linkage assembly of claim 8 further comprising;
an input coupling configured to connect the input end of the flexible cable for common rotational movement and axial movement with an output member of the shift lever; and
an output coupling configured to connect the output end of the flexible cable for common rotational movement and axial movement with the gear selector of the transmission.

10. The shift linkage assembly of claim 9 further comprising a plurality of brackets for grounding the shift linkage assembly to a support structure of the motor vehicle.

11. The shift linkage assembly of claim 10, further including an input axis extending from the input end of the flexible cable and an output axis extending from the output end of the flexible cable, wherein the input axis is radially offset and non-parallel to the output axis.

12. The shift linkage assembly of claim 11, wherein the flexible housing guides the axial translational movement of the flexible cable without inhibiting the rotational movement of the flexible cable.

13. The shift linkage assembly of claim 12, wherein the flexible cable includes a central flexible wire core and a plurality of wire bundles spirally wrapped onto the central wire core to buttress the central wire core from plastic deformation due to the rotational and axial translational movements.

14. A manual gear selector assembly for a manual transmission of a motor vehicle, comprising:
a shift lever configured to slideably pivot through a predetermined pattern for the selection of desired gear ratios and an output member configured to transmit a rotational movement and an axial translational movement based on the selected gear ratios; and
a shift linkage assembly including a shift cable rod having a flexible cable, wherein the flexible cable includes an input end coupled for common rotational movement and axial translational movement with the output member of the shift lever and an opposite output end configured to couple to a gear selector of the manual transmission for common rotational movement and axial translational movement with the gear selector.

15. The manual gear selector assembly of claim 14, wherein the flexible cable is configured to transmit substantially the same amount of rotational movement and translation movement received from the output member of the shift lever to the gear selector.

16. The manual gear selector assembly of claim 15, wherein an input axis extending from the input end of the flexible cable is radially offset and non-parallel to an output axis extending from the output end of the flexible cable.

17. The manual gear selector assembly of claim 16, wherein the shift cable rod further includes a flexible housing coaxially disposed about the flexible cable, a lubricant disposed between the flexible housing and flexible cable, and a housing jacket disposed on the flexible housing, wherein the housing jacket defines a plurality of ribs extending the length of the cable shift rod.

18. The manual gear selector assembly of claim 17, wherein the flexible cable includes a central flexible wire core and a plurality of wire bundles spirally wrapped onto the central wire core to buttress and reinforce the central wire core from deformation due to the torsional, compression, and tensile forces such that the rotational movement and axial translational movement received by the input end is common with the rotational movement and axial translational movement transmitted through the flexible cable to the output end.

19. The manual gear selector assembly of claim 18, further including a plurality of brackets for grounding the shift linkage assembly to a support structure of the motor vehicle.

20. The manual gear selector assembly of claim 19, wherein the input end is oriented toward the front of the vehicle and the output end is oriented toward the rear of the vehicle.
